(19) United States
(12) Patent Application Publication
(10) Pub. No.: US 2005/0089190 A1
(43) Pub. Date: Apr. 28, 2005

(54) Recording content distribution information into an adjunct to content

(76) Inventor: Eyal Shavit, (US)

Correspondence Address: PATENT DEPARTMENT;MACROVISION CORPORATION, 2830 DE LA CRUZ BLVD., SANTA CLARA, CA, 95050, US

(21) Appl. No.: 10/692,259

(22) Filed: Oct. 23, 2003

(51) Int. Cl. G06K 9/00

(52) U.S. Cl. 382/100

(57) ABSTRACT

Recording content distribution information into authorized copies of content is performed by modifying an adjunct to content with content distribution information using a functional transformation each time an authorized copy of the content is generated. By thus modifying the adjunct to content, a trail of content distribution information is stored in the adjunct that is extractable from the adjunct in any of such generated copies by sequentially performing an inverse transformation on the adjunct until information of an original copy is detected.

### FIELD OF THE INVENTION

The present invention generally relates to the distribution of content and in particular, to recording content distribution information into an adjunct to content for distribution tracking and other useful purposes.

### BACKGROUND OF THE INVENTION

The proliferation of personal computers with read/write devices such as CD-R/W and DVD-R/W, and the widespread acceptance of the Internet have become both boon and bane to content providers. The distribution of content on tangible media such as CD and DVD has become standard practice for some time now for authorized copying and distribution, because of their large storage capacity and low media cost. With the availability of high speed Internet connections, distribution through downloading of content is proving to be even more beneficial as a convenient and low cost distribution medium since it eliminates the cost of the tangible medium, the cost of its shipping to a customer, and the time that the customer has to wait for the purchased product. Unfortunately, however, these same mediums have also facilitated the unauthorized copying and distribution of content.

Various copy control systems such as Digital Rights Management (“DRM”) have been proposed and/or implemented with varying degrees of success to control the copying of content. In such systems, copy control information indicating whether the content may be copied and/or how many times it may be copied, is commonly provided in an adjunct to the content specifically dedicated for rights conveyance.

In addition to controlling the copying of content, it would also be useful for enforcement, market analysis and other purposes to know content distribution information such as a trail of copier related information or a trail of network nodes participating in the distribution of content. For example, when the content distribution information is copier related information, then the copier related information may include information related to the generation of a copy of the content, such as any one or more of the following: information as to the identification of the copier (e.g., a user identification of a user of the copier or an IP address of the copier), information as to how the copy was generated (e.g., information as to when the copy was generated (e.g., the time of copy generation or other processing according to a specified time zone or the time zone associated with the copier), what computer platform and operating system was used), and information as to the format that the copy was generated into (e.g., a downloadable file residing in computer memory or a file stored on a tangible, removable medium).

Copier related information for the entire chain of copying including any one or more of who (e.g., IP address of the copier), when (e.g., time of copy generation by the copier), how (e.g., platform of the copier), and what (e.g., format of the copy) is referred to as the “trail of copier related information” or the “content transformation path” of the content. Information of the content transformation path of a copy is useful for various purposes. One use is to identify “leaks” in the distribution channels (e.g., sources of unauthorized or illegal copying). For example, if there are multiple copies of content that all have the exact same content transformation path, then the leak is directly traced to the last legitimate transformation in the path. Another use is to analyze the distribution channels that a copy has gone through for marketing purposes so that producers of the content will know where and how to distribute their content more effectively.

On the other hand, when the content distribution information is a trail of network nodes participating in the distribution of content, for example, over the Internet, then the content distribution information may include for each packet of information, the IP address of each network node that has relayed the packet up to that point on its way to its final destination. This information may then be used to determine or at least give insights into the topology of a network that includes the network nodes, and/or to the manner in which content propagates in such a network. For example, information of such sort many be especially useful in determining the network topology of a peer-to-peer (“P2P”) network, and/or the manner in which content propagates in a P2P network.

### OBJECTS AND SUMMARY OF THE INVENTION

An “adjunct” to content is something that is associated with the content, but not necessarily a part of it. Adjuncts commonly contain information about the content and/or rights associated with the content. Examples of adjuncts include meta data included in a carrier containing rights associated with the content such as in a DRM wrapper, a watermark that is added or embedded in the content, or a signature such as a Digital Signature or message digest or hash value related to the content that is added to, joined with, or otherwise associated to the content. In common applications for an adjunct to content, information in the adjunct is extracted and used to trigger some action by a screening system when the content is to be played or copied or otherwise consumed.

In brief, the adjunct establishes a link between the content and corresponding information. It is commonly included in each copy of the content independent of the physical format of the copy. Sometimes, however, it is stored remotely (i.e., not stored in the same physical location as the content), but associated with content. As the content is propagated through various distribution channels in copies of the content, the content may be repeatedly transformed in those copies (i.e., changed in format). The adjunct, however, is generally not changed in a way that captures what those transformations were or the identities of the copiers. Thus, conventional adjuncts are figuratively memory-less, since they are completely non-informative about the sequence of transformations that the content has undergone or the identities of entities performing those transformations.

If adjuncts had memory, then they could provide dynamic information such as information of content distribution as well as conventionally provided static information such as copy control, origin and ownership of the content. For example, in the case where the content distribution information includes copier related information, the term “dynamic” means that the adjunct to the content is modified at the file or object level each time a copy of the content is generated so as to include copier related information for the generation of that copy. Thus, a trail of copier related information for a chain of copying from an original copy up to the current copy would be contained in the adjunct to the current content. In the case where the content distribution information includes a trail of network nodes participating in the distribution of content, such as in a P2P network, the term “dynamic” means that the adjunct to content is modified at the packet level each time a packet is relayed through a network node on its way to its final destination. The modification in this case may include the IP address of the network node performing the relay, and information indicating the time of such relay.

If a “direct” approach is used for adding content distribution information to an adjunct to content such as serially adding or concatenating additional information of content distribution to the adjunct each time its associated content is copied or relayed or otherwise undergoes a transformation, then the size of the adjunct grows as the content distribution path gets longer. This may result in objectionable deterioration in the quality of the underlying content when, for example, the adjunct is a watermark embedded in the content, as well as increasing the complexity of embedding information for each successive copy and/or extracting such information of successive copying back out again. An “indirect” approach is therefore preferable where the content distribution information is not explicitly included in the adjunct as a “list”. In such an indirect approach, the content distribution information is preferably manifested instead in a set of reversible transformations that are embedded as a function in the adjunct to content.

Accordingly, it is an object of the present invention to provide a method for recording content distribution information into an adjunct to content that does not substantially increase the size of the adjunct as the content distribution path gets longer.

Another object is to provide a method for recording content distribution information into an adjunct to content that is relatively easy to implement and computationally simple to perform.

Another object is to provide a method for extracting content distribution information from an adjunct to content so as to provide information of a content distribution trail.

Still another object is to provide an apparatus that records information of content distribution in an adjunct to content for each copy of the content generated by the apparatus.

Yet another object is to provide an apparatus for extracting information of content distribution from a current copy of content so as to provide information of a trail of copying from an original copy of the content to the current copy of the content.

These and additional objects are accomplished by the various aspects of the present invention, wherein briefly stated, one aspect is a method for recording content distribution information in an adjunct to content, comprising: providing copier related information for a succession of copies of content in the adjunct to the content.

Another aspect is a method for recording content distribution information into an adjunct to content, comprising: adding copier related information into an adjunct to content upon each generation of an authorized copy of the content.

Another aspect is a method for recording content distribution information in an adjunct to content, comprising: performing a functional transformation on an adjunct to content each time an authorized copy of the content is generated so that the adjunct is modified to include copier related information.

Another aspect is a method for recording content distribution information in an adjunct to content, comprising: performing a functional transformation on an adjunct to content in a packet of data when the packet of data is relayed by a network node so that the adjunct is modified to include identifying information of the network node.

Another aspect is a method for extracting content distribution information from a copy of content, comprising: successively performing an inverse transformation on an adjunct to a copy of content so as to extract content distribution information from an adjunct until information of an original copy of the content is detected.

Another aspect is a method for extracting content distribution information from a packet of data, comprising: sequentially performing an inverse functional transformation on and extracting content distribution information from an adjunct to content in the packet of data until information of a source of the packet of data is detected.

Still another aspect is an apparatus for providing content distribution information in an adjunct to content, comprising a copier configured to modify an adjunct to content by adding information associated with the copier to the adjunct when the copier is proceeding to have a copy generated which includes the modified adjunct and the content.

Yet another aspect is an apparatus for extracting content distribution information from a copy of content, comprising a device configured to sequentially perform an inverse transformation on and extract content distribution information from an adjunct to content until information of an original copy of the content is detected.

Additional objects, features and advantages of the various aspects of the present invention will become apparent from the following description of its preferred embodiment, which description should be taken in conjunction with the accompanying drawings.

### BRIEF DESCRIPTION OF THE DRAWINGS

FIG. 1 illustrates a block diagram of a chain of processing units recording content distribution information in an adjunct to content, utilizing aspects of the present invention.

FIG. 2 illustrates a flow diagram of a method preferably performed by a copier as part of a copy control system for providing content distribution information in an adjunct to content when generating a copy of the content, utilizing aspects of the present invention.

FIG. 3 illustrates a block diagram of a chain of copiers for recording content distribution information in copies of content generated on tangible, removable media by the chain of copiers, utilizing aspects of the present invention.

FIG. 4 illustrates a block diagram of a system including a chain of copiers for recording content distribution information in copies of content generated in downloadable files, and at least one computer for extracting content distribution information from selected ones of those copies, utilizing aspects of the present invention.

FIG. 5 illustrates a flow diagram of a method preferably performed by a network node for providing content distribution information in an adjunct to content received in a packet of data, utilizing aspects of the present invention.

FIG. 6 illustrates a flow diagram of a method for extracting content distribution information from an adjunct to content, utilizing aspects of the present invention.

FIG. 7 illustrates a numerical example of successively performing a functional transformation on an original adjunct to content to store content distribution information in the adjunct, utilizing aspects of the present invention.

FIG. 8 illustrates a numerical example of successively performing an inverse transformation on an adjunct to content to extract content distribution information from the adjunct, utilizing aspects of the present invention.

### DETAILED DESCRIPTION OF THE PREFERRED EMBODIMENT

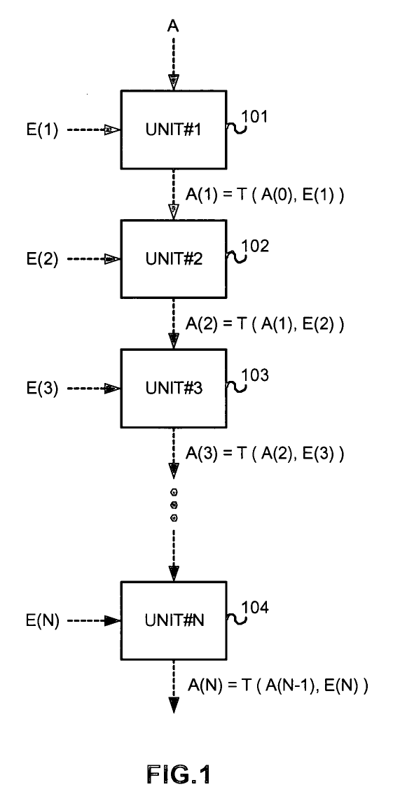

FIG. 1 illustrates, as an example, a block diagram of a chain of N processing units (including units 301-304) recording content distribution information in a preferred manner in an adjunct to content as the content is being distributed through the N units. The outputs of each of the N units in this case may be of the same format or different formats.

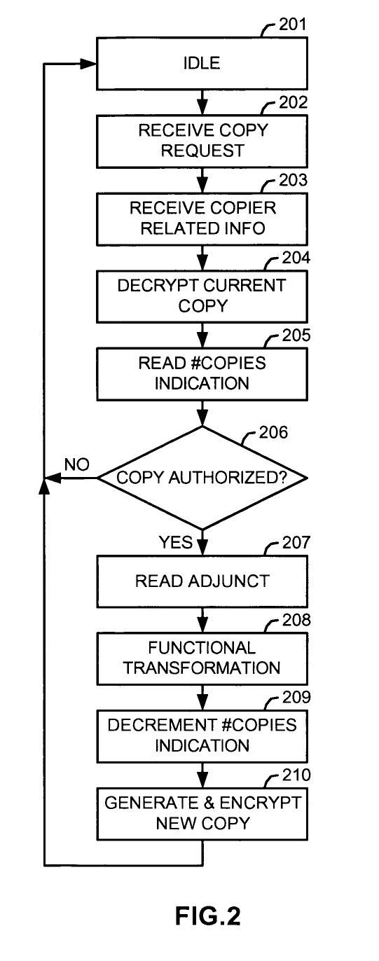

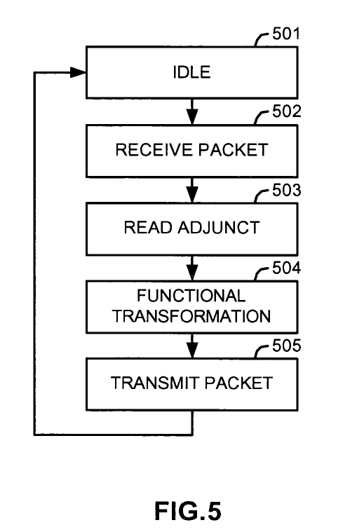

Although in the following description, it is assumed that each of the N units is a copier that generates a copy of the content as described, for example, in reference to FIGS. 2˜4, various teachings as described in reference to the block diagram are also applicable in the case where each of the N units is a network node that transmits a packet containing content as described, for example, in reference to FIG. 5.

In the example, “A(0)” is the original adjunct to content received in an original copy of the content by copier 101 and “E(1)” is the copier related information for generation of a first authorized copy by the copier 101. The original copy in this case is the first copy in a succession of copies, the first authorized copy is the second copy in the succession of copies, and the copier 101 is the first copier in the chain of copiers. By applying a functional transformation “T” to the original adjunct “A(0)”, a modified adjunct “A(1)” is generated:
A(1)=T(A(0),E(1)) (1)

A “functional transformation,” as the term is generally understood in mathematics, is a map (i.e., function) whose domain is some set of functions. Thus, functional transformations are functions acting on functions. A well-known example of a functional transformation is the derivative. The derivative is applied to a function, and the result is another function.

The functional transformation used herein has several important characteristics. First, it is characterized by having an inverse transformation that allows extraction of the copier related information back from the modified adjunct. Hence, it is referred to herein as a “reversible transformation.” Second, it preferably preserves the size of the adjunct independent of the number of times a functional transformation is performed on it, such as for successive copies of the content by a chain of copiers. By maintaining the size of the adjunct, the functional transformation does not reduce the robustness of the adjunct or the efficiency of embedding and extracting it to and from the content.

The adjunct A(1) is now the adjunct to the content in the copy received by copier 102 (i.e., the second copier in the chain of copiers receiving the second copy in the succession of copies). Since “E(2)” is the copier related information for generation of a copy by the copier 102, a modified adjunct “A(2)” is generated by applying the functional transformation “T” to the adjunct “A(1)” as follow:
A(2)=T(A(1),E(2)) (2)
By replacing “A(1)” with equation (1), “A(2)” can also be expressed as:
A(2)=T((T(A(0),E(1)),E(2)) (3)
This is now the adjunct to the content in the copy received by copier 103 (i.e., the third copier in the chain of copiers receiving the third copy in the succession of copies). Since “E(3)” is the copier related information for generation of a copy by the copier 103, a modified adjunct “A(3)” is generated by applying the functional transformation “T” to the adjunct “A(2)” as follow:
A(3)=T(A(2),E(3)) (4)
By replacing “A(2)” with equation (3), “A(3)” can also be expressed as:
A(3)=T(T((T(A(0),E(1)),E(2))),E(3)) (5)
This process continues for each copier in the chain of copiers until copier 104 receives a copy of the content (i.e., the Nth copier in the chain of copiers receives the Nth copy of the content in the succession of copies). Straightforward extension of the equations (1), (2), and (4) indicates a modified adjunct of:
A(N)=T(A(N−1),E(N)) (6)
for the copy of the content generated by the copier 104, where “E(N)” is the copier related information for generation of a copy by the copier 104, and “A(N−1)” is the adjunct to the content of the copy received by the copier 104.

FIG. 2 illustrates, as an example, a flow diagram of a method performed in this case by a copier as part of a copy control system for providing content distribution information in an adjunct to content when the copier generates a copy of the content. If a subsequent copy is generated from the generated copy by the same or a different copier, then the method described as follows in reference to 202-210 is also performed for that subsequent copy so that the a recording of content distribution information for the succession of copies is provided in the adjunct to content in the subsequent copy.

In 202, the copier receives a request to generate a copy of content from a user of the copier. The term “copier” as used herein includes personal computers and other devices that are configured through either or both hardware and software to generate an authorized copy of content according to this method. The term “content” as used herein includes copyrightable material (such as audio, video, audio-visual, text, graphic images, and computer programs), as well as generally non-copyrightable material such as data. The term “authorized” as used herein means authorized by the owner of the content either directly or indirectly through the owner's agents, representatives, or licensees. The term “user” as used herein means the operator using or otherwise controlling the copier.

In 203, the copier receives copier related information such as information of a user identification associated with the user of the copier, or an IP address associated with the copier, or information of a copy device if used in generating a copy of the content by the copier. The term “copy device” as used herein includes digital writers such as CD and DVD read/write drives, as well as analog and other recording devices.

In 204, the current copy of the content is decrypted in a conventional fashion by the copier using a key provided to or already present in the copier. In 205, an indication of the number of copies authorized to be generated from the current copy is read from a predefined location in the decrypted copy of the content. The term “copy of the content” as used herein means a copy of the content as well as an adjunct to the content. In 206, the copier determines whether the requested copy is allowable by checking the number of authorized copies indication read out in 205. If the number of copies indication is one or more, then the requested copy is allowed or authorized to be generated, and the method proceeds to 207. On the other hand, if the number of copies indication is zero, then the method jumps to 201, which places the copier back into an idle state.

In 207, an adjunct to the content is read. In 208, the adjunct is modified by performing a functional transformation (such as described in reference to FIG. 1) on the adjunct using the copier related information received in 203. After modifying the adjunct by adding copier related information to it, in 209, the indication of the number of copies authorized to be generated from the current copy is decremented, and the decremented value written back into the predefined location in the decrypted copy of the content so as to overwrite the original number read out in 205. Finally, in 210, a new copy of the content is generated by encrypting the previously decrypted content (along with the modified adjunct and decremented number of authorized copies). The method then jumps to 201 to place the copier back into the idle state.

Although described as being used in conjunction with a copy control system, it is to be appreciated that the method for recording content distribution information described herein can also be performed without the copy control system functions 205, 206, and 209, and without the decryption and encryption functions 204 and 210, and therefore, the method and scope of any claims directed to the method is not to be restricted in any manner as requiring such functions.

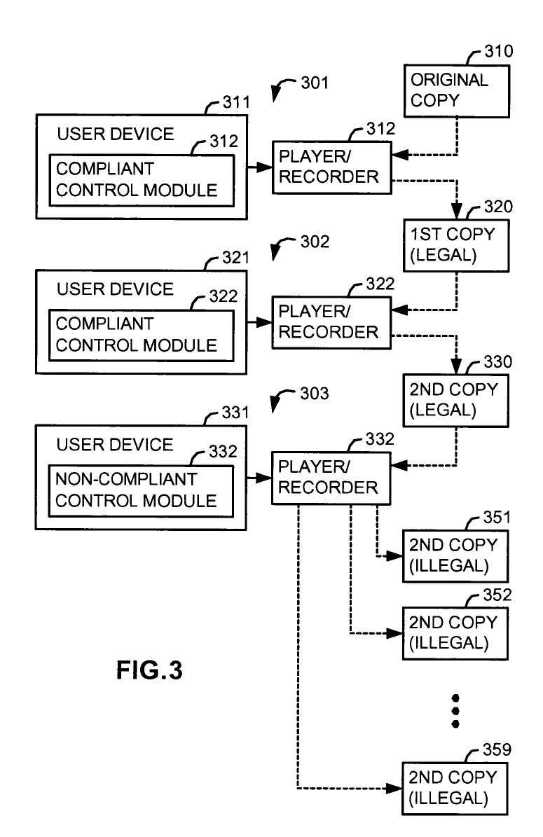

FIG. 3 illustrates, as an example, a block diagram of a chain of unconnected copiers 301 and 302 recording content distribution information in their respectively generated copies of content on tangible, removable media 320 and 330. In each of the generated copies, the content distribution information recorded therein includes copier related information for a chain of copiers used in generating a succession of copies leading up to the current generated copy. Copiers 301 and 302 are referred to as being “compliant copiers” since they respond to copy control information stored on received copies (such as 310 and 320, respectively) to only generate authorized or legal copies (such as 320 and 330, respectively) of the content. Copier 303, on the other hand, is referred to as being a “non-compliant copier” since it ignores such copy control information stored on a received copy (such as 330), thereby allowing non-authorized or illegal copies (such as 351˜359) to be generated.

Each of the copiers 301, 302 and 303 comprises two primary hardware components—a user device (i.e., 311, 312 and 313, respectively) such as a personal computer, and a player/recorder or other digital player and writer device (i.e., 312, 322 and 332, respectively) such as a CD or DVD RW disk drive. The user devices 311 and 321 are configured with compliant control modules 312 and 322 that make their respective copiers act as compliant copiers. The user device 331, on the other hand, is configured with a non-compliant control module 332 which allows its copier to act as a non-compliant copier.

Copies 310, 320 and 330 are referred to as being a “succession of copies” since copy 330 is generated from copy 320, and copy 320 is generated in turn from copy 310 (as indicated by dotted lines in FIG. 3). Copiers 301 and 302 are referred to as being a “chain of copiers” since they generate a succession of copies. Although shown as different copiers in this example, a chain of copiers may include the same copier more than once in the chain. It is to be noted that copies 351˜359 are not a succession of copies since they are not generated from one another. Each of these copies is illegally generated from a same source copy 330. Since the source copy 330 was a legal copy in this example, each of the illegal copies 351-359 will include the copier related information included in copy 330, thereby indicating that the user of copier 302 was the party that “leaked” or passed the content to the user operating the non-compliant copier 303.

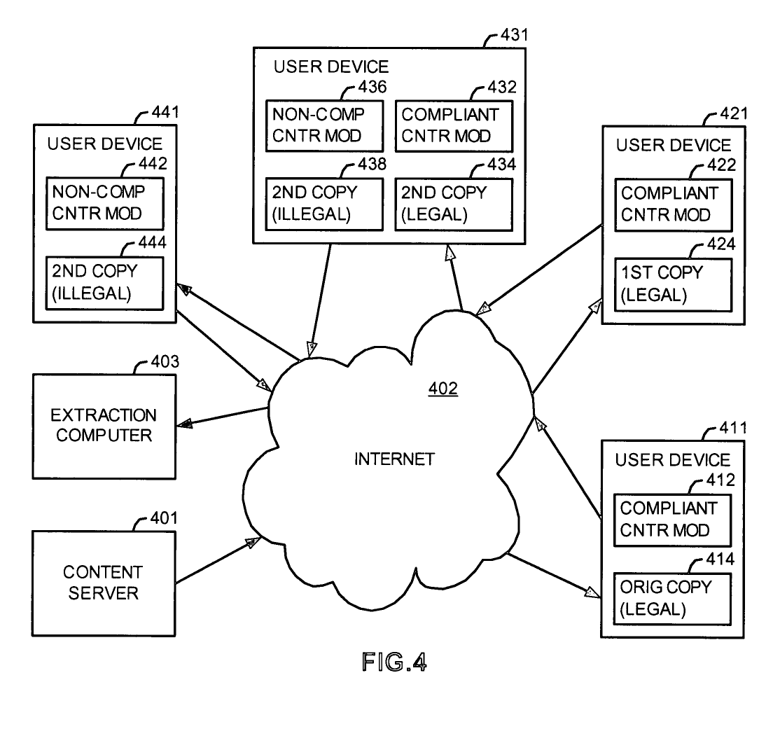

FIG. 4 illustrates, as an example, a block diagram of a system including a content server 401, a number of user devices (e.g., 411, 421, 431, and 441), and an extraction computer 403 communicating with one another over the Internet 402. Each of the user devices includes a processor unit for running a control module that controls the use and copying of content. A typical example of such a user device is a personal computer.

User devices 411 and 421 respectively include compliant control modules 412 and 422 that only allow authorized copying of content by responding to copy control information stored along with or embedded in the content. User device 441, on the other hand, includes a non-compliant control module that does not respond to such copy control information, thereby allowing unauthorized copying of the content. User device 431 includes both a compliant control module and a non-compliant control module.

In this example, user device 411 legally downloads an original copy of content 414 from the content server 401 over the Internet 402 after the user or operator of the user device 411 arranges for its payment in any one of various conventional manners such as in a Digital Rights Management system. For the purposes of this example, the copy 414 comes along with a right to make and distribute two additional copies of the content. Information of this right is stored in the copy 414 in a secret location known to compliant control modules, but not necessarily known to non-compliant control modules.

When user device 421 is authorized to download a copy 424 of the content over the Internet 402 from the user device 411, such downloading is preferably managed by the compliant control modules 412 and 422 communicating and cooperating with one another. Before downloading the copy 424 to the user device 421, the copy 424 is generated as a downloadable file and stored in memory on the user device 411. The original copy 414 is also modified to indicate any retained rights to make and distribute additional copies beyond that of the copy 424.

The copy 424 is generated so as to include copier related information in its adjunct by modifying the adjunct included in the copy 414 with the copier related information in generally the same manner as described in reference to 203˜208 of FIG. 2. In addition to information of the copier (i.e., information of the copier or user device 411 in this case, and/or information of its user or operator), information of the receiving user device 421 (such as its IP address) and/or its user is also preferably included in the modified adjunct to content included in the copy 424.

The stored right to make additional copies is also modified in the copy 414. If the right to make a second copy is retained by the user device 411, then the copy 414 is modified to indicate that only one additional copy may be made and distributed from it, and the copy 424 is generated so as to indicate that no copies may be made from it. On the other hand, if the right to make a second copy is transferred along with the copy 424 to the user device 421, then copy 414 is modified to indicate that no more copies may be made from it, and the copy 424 is generated so as to indicate that only one copy may be made and distributed from it.

Assuming that the right to make and distribute one more copy is transferred along with the copy 424 to the user device 421, then when user device 431 is authorized to download a copy 434 of the content over the Internet 402 from the user device 421, such downloading is preferably managed by the compliant control modules 422 and 432 communicating and cooperating with one another. Before downloading the copy 434 to the user device 431, the copy 434 is generated as a downloadable file with no rights to make additional copies indicated therein, and stored in memory on the user device 421. The first copy 424 is also modified to indicate that there are no remaining rights to make or distribute any copies of the copy 424.

The copy 434 is generated so as to include copier related information in its adjunct to content by modifying the adjunct included in the copy 424 with the copier related information in generally the same manner as described in reference to FIG. 1 for successive copies. In addition to information of the copier (i.e., information of the copier or user device 421 in this case, and/or information of its user or operator), information of the receiving user device 431 (such as its IP address) and/or its user is also preferably included in the modified adjunct included in the copy 434.

In this case, the succession of copies includes the original copy 414, the first copy 424, and the second copy 434 of the content, and the chain of copiers includes the user devices 411 and 421. If the user of the user device 431 thereafter makes an illegal copy 438 of the legal second copy 434, the illegal copy 438 would include copier related information in its adjunct to the content indicating at least the chain of copiers, and information of the receiving user device 431 of the second copy 434 if that information was also included in the adjunct by the user device 421 when generating the second legal copy 434. Consequently, any copies of the illegal copy 438, such as copy 444 residing on user device 441, would also have such copier related information included in its adjunct to content.

Now, assuming that the right to make and distribute one more copy is retained by the user device 411, then when user device 431 is authorized to download a copy 434 of the content over the Internet 402 from the user device 411, such downloading is preferably managed by the compliant control modules 412 and 432 communicating and cooperating with one another. Before downloading the copy 434 to the user device 431, the copy 434 is generated as a downloadable file with no rights to make additional copies indicated therein, and stored in memory on the user device 411. The original copy 424 is also modified to indicate that there are no remaining rights to make or distribute any more copies of the original copy 414.

The copy 434 is generated so as to include copier related information in its adjunct by modifying the adjunct to content included in the copy 414 with its copier related information in generally the same manner as the adjunct included in the copy 424. In addition to information of the copier (i.e., information of the copier or user device 411 in this case, and/or information of its user or operator), information of the receiving user device 431 (such as its IP address) and/or its user is also preferably included in the modified adjunct included in the copy 434.

In this second case, there are two successions of copies. The first includes the original copy 414 and the first copy 424, and the second includes the original copy 414 and the second copy 434. In both cases, the chain of copiers only includes the user device 411 since it made both copies 424 and 434 and distributed them to the user devices 421 and 431. If the user of the user device 431 thereafter makes an illegal copy 438 of the legal second copy 434, the illegal copy 438 would include copier related information in its adjunct indicating the user device 411 as being the last one in its chain of copiers, and indicating the user device 431 as receiving the last authorized or legal copy 434 if that information was also included in the adjunct by the user device 411 when generating the second legal copy 434. Consequently, any copies of the illegal copy 438, such as copy 444 residing on user device 441, would also have such copier related information included in its adjunct to content.

If an illegal copy is detected or otherwise made available to the extraction computer 403, the extraction computer 403 can perform a succession of inverse transformations on the adjunct to content in the copy so as to extract the copier related information stored therein by compliant control modules such as 412 and 422. From this information, the user of the extraction computer 403 can identify at least the user and/or user device generating the last authorized copy of the illegal copy, and the recipient of that last authorized copy if that information is included in the copier related information stored in the adjunct.

In addition to the arrangements described in reference to FIG. 3 in which a succession of copies were each generated on tangible media, and in reference to FIG. 4 in which a succession of copies were each generated as a computer file, other arrangements including hybrids of these two are fully contemplated as being applicable to and usable with the claimed method for recording content distribution information in an adjunct to content. In particular, in a Peer-to-Peer (“P2P”) arrangement, an original copy of the content may be provided on tangible media such as a CD or DVD, and subsequent copies may be generated as downloadable files shared on the Internet. The original copy in this case, as well as all others described herein, may or may not be copy protected. Alternatively, in another P2P arrangement, the original copy may be downloaded by a cable company or other media distribution company to a consumer's set-top box which may then make a back-up copy on tangible media and/or be connected to a home network through which subsequent copies may be generated as downloadable files shared on the Internet.

FIG. 5 illustrates, as an example, a flow diagram of a method preferably performed within a network node of a network such as a P2P network on the Internet for recording content distribution information in an adjunct to content that is received in a packet of data. In 501, the method is initially in an idle state. In 502, a packet of data is received from either a source or a prior network node of the network. In 503, an adjunct to content contained in the packet is read. In 504, a functional transformation such as described in reference to FIG. 1 is performed on the adjunct including information that identifies the network node such as its IP address. If the network node is part of a dynamically changing network (i.e., where each node is represented by a computer operated by an end user, and end users are constantly joining and exiting the network), such as in a Kazaa network, a time stamp or other information indicating the time that a packet is being received and/or relayed by the network node is preferably also included in the modified adjunct by the functional transformation. In 505, the packet with the modified adjunct is then transmitted or sent off into the network to either a next network node or its final destination.

If all network nodes that the packet travels through between a source node and final destination node perform 501˜505 on the packet, then the packet received at the final destination will contain a complete trail of network node identifiers indicating the content distribution path through which the packet has traveled. Since other packets associated with the same content may travel through different distribution paths including different source nodes, an indication of the network topology between the source and final destination nodes may be determined by analyzing the content distribution information contained in the adjuncts of all such packets.

If access to the final destination is not available, for example, because it is participating in an inappropriate act by receiving unauthorized content from the source, then packets in transit may be sniffed out or otherwise intercepted by, for example, a BOT or web crawler that is used to scour the network, pick up packets, analyze the content distribution information contained in adjuncts to content included in the packets, and then send the packets along their way to their final destination(s). This type of action would not require cooperation by either the source or final destination, and could lead to valuable information of the network topology leading back to the source of the packet transmission.

For a dynamically changing network such as a distributed network with de-centralized control, the determination of the network topology should be for a specific time (or time period) since the network topology changes over time. The network topology in this case may be thought of as a dynamically changing network graph with the network node identifiers and related time information extracted from adjuncts to content in packets of data indicating specific paths in the network graph. If large long lasting trends in the network topology turn out to be not so dynamic, then this information may be used to form heuristics about searches and actions taken in utilizing the network. In addition to determining network topology, “supernodes” (i.e., centralized nodes with higher priorities and activity levels) as well as duplicate or unimportant nodes in the network graph may be identified. This information allows for improved searches on the network by removing the duplicate or unimportant nodes from the network graph and providing guidance on where to look first (i.e., the identified supernodes). In addition, such knowledge of the network topology can also be used to “spoof” the network.

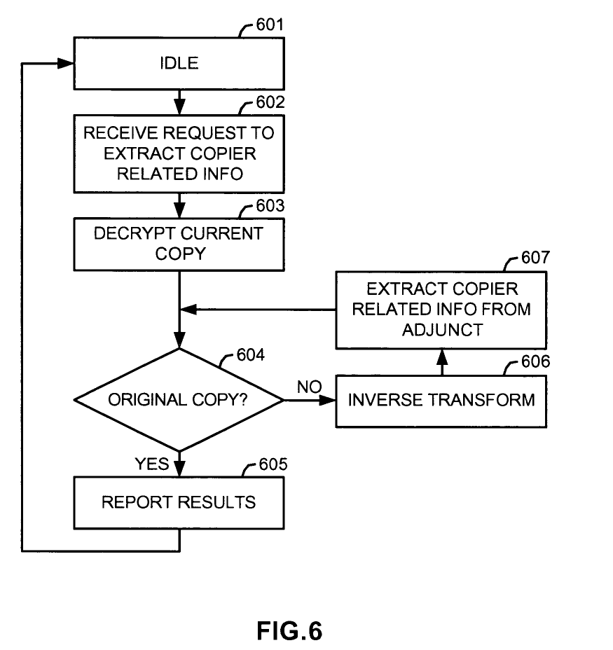

FIG. 6 illustrates, as an example, a flow diagram of a method for extracting content distribution information from an adjunct to content included in a current copy generated as one of a succession of copies such as described in reference to FIG. 1. Although the example is described in reference to extracting copier related information at the file or object level, the extraction technique described herein is equally applicable with appropriate modification for extracting network identifier or other information contained in adjuncts at the packet level.

The copy in this case is referred to as being the current copy, because it is the copy currently being processed by the method. The method is performed by an extraction program residing, for example, on a computer such as the extraction computer 403 of FIG. 4, or a consumer electronics device such as a DVD player or a set-top box. Although not an essential part of the method, the extraction program may also have the ability and authority to decrypt before reading the adjunct to the content such as described in reference to the compliant control module 312 in FIGS. 3 and 412 in FIG. 4.

In 602, the extraction program is initiated when it receives a request by a user of the extraction computer to extract copier related information from the adjunct to the content in the current copy. In 603, it decrypts, if necessary, the current copy in a similar manner as described in reference to 204 of FIG. 2.

In 604, the extraction program checks whether the current copy is an original copy of the content, such as the original copies described in reference to 310 in FIG. 3 for a “hard” copy (i.e., on a tangible medium) of the content and 414 in FIG. 4 for a “soft” copy (i.e., in intangible form such as a downloadable file in memory) of the content. In order to determine whether the current copy is the original copy, an indication of such is preferably included in the adjunct. The indication may be a copy number in the succession of copies, starting, for example, with copy number zero for the original copy and incremented by one for each subsequent copy in the succession of copies by the compliant control module generating the copy. On the other hand, the indication may be simply a pattern of bits indicating that the current copy is an original copy of the content that the extraction program recognizes or can otherwise look up through some resource such as the content server described in reference to 401 in FIG. 4, an example of which is an ID code connected to a list stored in a backend database.

If the current copy is the original copy, then in 605, the result is reported to the user of the extraction computer, and the method jumps back to 601 to re-enter the idle state. On the other hand, if the current copy is not the original copy, then in 606, the method performs an inverse transformation on the adjunct, and in 607, extracts the copier related information corresponding to the generation of the current copy from the adjunct. The copier related information is then preferably stored for later reporting after extracting all copier related information in the adjunct. The inverse transformation in this case is related to the functional transformation that modified the adjunct to include the copier related information such as described in reference to 208 in FIG. 2. After performing the inverse transformation, the adjunct for the prior copy of the content is extracted along with the copier related information in generating the current copy. The method then jumps back to 604 to determine if the adjunct for the prior copy indicates the original copy of the content, and continues to loop through 604˜607 until an indication is found in one of the inverse transformed adjuncts indicating that the original copy has been reached. Upon such determination, then in 605, the results for the copier related information for the entire trail of copying is reported out to the user of the extraction computer, and the method jumps back to 601 to re-enter the idle state.

An example now follows to provide a better appreciation of a functional transformation and its inverse transformation as used herein. In the example, let the general form of a functional transformation on the adjunct be:
T(A,E,K)={T(A,E)|T(E,K)} (7)
where “T” is the functional transformation, “A” is the adjunct to content, “E” is the copier related information, “K” is a master key for securing the adjunct against unauthorized tampering, and the symbol “|” indicates the operation of concatenation.

To simplify the following description, the master key “K” can be assumed to be a secret key that is shared by a compliant control module that performs the functional transformation to include copier related information in the adjunct, and an extraction program that extracts the copier related information from the adjunct. In actual implementation, however, a mechanism based on the public key of the content playing or screening application may be used, as is common in conventional security applications.

If the functional transformation is an exclusive-OR function “XOR” that is performed on an original adjunct “A(0)” using copier related information “E(1)” for generation of the first authorized copy, then the modified adjunct “A(1)” resulting from the functional transformation and to be included in the first authorized copy of the content is equal to the following:
A(1)={XOR(A(0),E(1))|XOR(E(1),K)} (8)
which can also be expressed as the following for simplification purposes:
A(1)=B1|B2 (9)
where,
B1=XOR(A(0),E(1)) (10)
B2=XOR(E(1),K) (11)

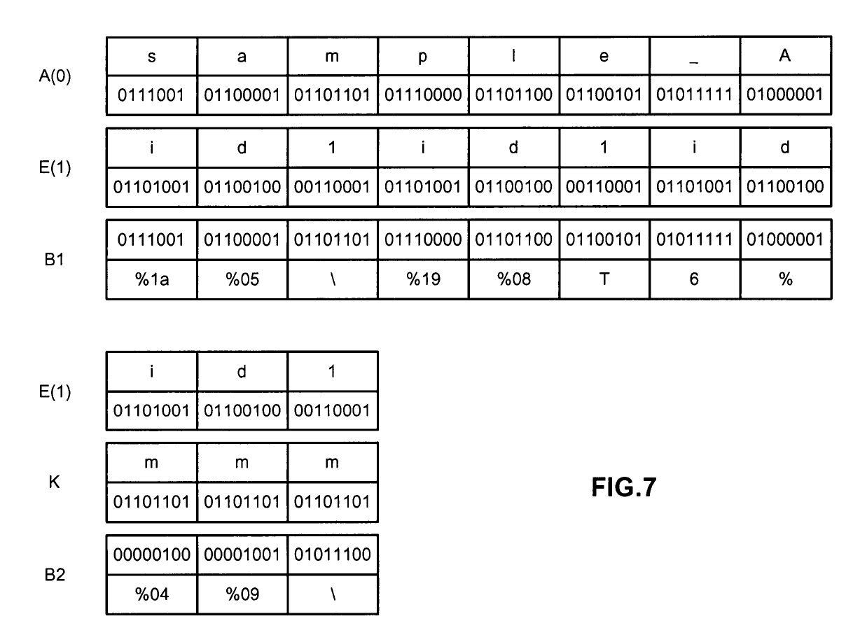

FIG. 7 illustrates an example of calculations using equations (10) and (11) for determining parts “B1” and “B2” of the first modified or transformed adjunct “A(1)”, where the original adjunct “A(0)”, the first copier related information “E(1)”, and the master key “K” have the following values:
A(0)=sample_{—}A (12)
E(1)=id1 (13)
K=m (14)

Going in the reverse direction, if an extraction computer receives the first copy including the modified adjunct “A(1)”, then the copier related information “E(1)” associated with the generation of that first copy, and the original adjunct “A(0)” to content in the original copy can be extracted from the adjunct “A(1)” in the current copy by applying an inverse transformation using the exclusive-OR “XOR” function as follows:
E(1)=XOR(B2,K) (15)
A(0)=XOR(B1,E(1)) (16)

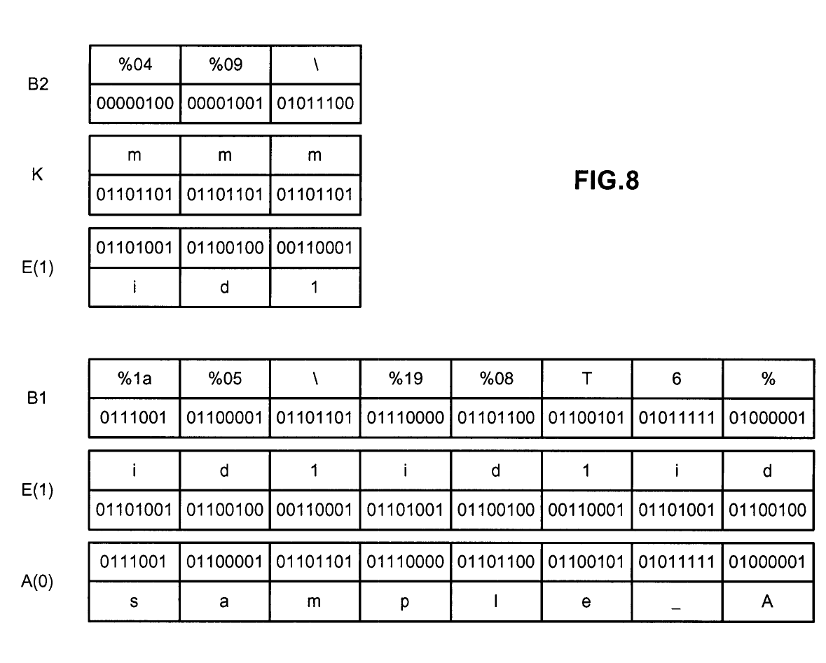

FIG. 8 illustrates an example of calculations using equations (15) and (16) for extracting “E(1)” and “A(0)” from the adjunct “A(1)” in the first authorized copy of the content, where the values for “B2” and “B1” are those calculated as shown in FIG. 7. As can be readily seen from the example, the copier related information “E(1)” associated with the generation of the first authorized copy and the original adjunct “A(0)” are shown as being successfully extracted back out of the adjunct “A(1)”.

The example may be further extended to include the generation of a second modified adjunct “A(2)” to content included in a second authorized copy of the content. Assuming copier related information “E(2)” for the generation of the second authorized copy, the modified adjunct “A(2)” to be included in the second authorized copy of the content is equal to the following:
A(2)={XOR(A(1),E(2))|XOR(E(2),K)} (17)
which can also be expressed as the following for simplification purposes:
A(2)=C1|C2 (18)
where,
C1=XOR(A(A),E(2)) (19)
C2=XOR(E(2),K) (20)

Now assuming that only the second authorized copy with the second transformed adjunct “A(2)” is received for extraction processing, then the following equations are used in sequence to extract the copier related information, “E(2)” and “E(1)”, for the second and first copies, and the first modified and original adjuncts, “A(1)” and “A(0)”:
E(2)=XOR(C2,K) (21)
A(1)=XOR(C1,E(2))=B1|B2 (22)
E(1)=XOR(B2,K) (23)
A(0)=XOR(B1,E(1)) (24)

Extending the above example for performing additional functional transformations corresponding to additional copies in a succession of copies is straightforward. Likewise, extending the above example for performing additional inverse transformations on the adjunct for subsequent copies in a succession of copies in order to extract the original adjunct and copier related information for a chain of copiers generating the succession of copies is also straightforward.

Although the various aspects of the present invention have been described with respect to a preferred embodiment, it will be understood that the invention is entitled to full protection within the full scope of the appended claims.

1. A method for recording content distribution information in an adjunct to content, comprising: providing copier related information for a succession of copies of content in the adjunct to the content.

2. The method according to claim 1, wherein said succession of copies are generated by a chain of copiers, and said providing copier related information comprises providing identifying information for said chain of copiers such that said identifying information is interconnected through successive modifications of the adjunct to the content.

3. The method according to claim 2, wherein a size of the adjunct to the content is substantially unchanged through said successive modifications of the adjunct to the content.

4. The method according to claim 2, wherein a complexity of individual of said successive modifications is approximately of a same level as others of said successive modifications of the adjunct to the content.

5. The method according to claim 2, wherein identifying information provided in prior of said successive modifications are preserved in subsequent of said successive modifications so as to be extractable from the adjunct to the content.

6. The method according to claim 1, wherein said providing copier related information comprises:
modifying the adjunct by adding individual copier related information for a copier of the content when the copier is proceeding to generate a copy of the content.

7. The method according to claim 6, wherein said modifying the adjunct comprises: generating a modified adjunct by performing a functional transformation using information of the adjunct prior to said modifying along with said individual copier related information.

8. The method according to claim 7, wherein said modified adjunct is provided with said copy of the content.

9. The method according to claim 7, wherein said functional transformation is characterized by an inverse transformation from which said individual copier related information is retrievable from said modified adjunct.

10. The method according to claim 9, wherein said functional transformation is an exclusive-OR function.

11. The method according to claim 7, wherein said adjunct is a watermark embedded in the content.

12. The method according to claim 7, wherein said adjunct is meta data in a DRM wrapper.

13. The method according to claim 7, wherein said adjunct is a signature related to the content.

14. The method according to claim 13, wherein said signature is a message digest calculated using the content.

15. The method according to claim 13, wherein said signature is a hash value calculated using the content.

16. The method according to claim 1, wherein said content is copyrightable material.

17. The method according to claim 1, wherein said individual copier related information includes information of a user identification associated with a user of the copier proceeding to generate the copy of the contents.

18. The method according to claim 1, wherein said individual copier related information includes information of an IP address associated with the copier proceeding to generate the copy of the content.

19. The method according to claim 1, wherein said individual copier related information includes information of a copy device used in generating a copy of the content by the copier proceeding to generate the copy of the content.

20. The method according to claim 19, wherein the copier proceeding to generate the copy of the content is a personal computer, and the copy device is a digital writer.

21. The method according to claim 20, wherein said digital writer is a CD writer.

22. The method according to claim 20, wherein said digital writer is a DVD writer.

23. The method according to claim 20, wherein the copier proceeding to generate the copy of the content is a consumer electronic device.

24. The method according to claim 23, wherein said consumer electronic device is a set-top box.

25. The method according to claim 21, wherein said consumer electronic device is a DVD player.

26. A method for recording content distribution, information into an adjunct to content, comprising: adding copier related information into an adjunct to content upon each generation of an authorized copy of the content.

27. The method according to claim 26, wherein said adding copier related information into an adjunct to content, comprises:
generating a modified adjunct by performing a functional transformation using information of the adjunct prior to generation of an authorized copy of the content along with copier related information associated with such generation; and
including the modified adjunct along with the content in the authorized copy.

28. The method according to claim 27, wherein said functional transformation is characterized by an inverse transformation from which said copier related information is retrievable from the modified adjunct.

29. The method according to claim 27, wherein said modified adjunct is characterized by a size, and said functional transformation does not increase said size when performed on said modified adjunct to generate a subsequently modified adjunct.

30. The method according to claim 29, wherein said functional transformation is further characterized by a complexity that is substantially the same when performed on said modified adjunct to generate said subsequently modified adjunct.

31. The method according to claim 26, wherein said adjunct is a watermark embedded in the content.

32. The method according to claim 26, wherein said adjunct is meta data associated with the content.

33. The method according to claim 32, wherein said meta data is included with the content.

34. The method according to claim 32, wherein said meta data is not included with the content.

34. The method according to claim 26, wherein said adjunct is a signature related to the content.

36. The method according to claim 26, wherein the content is copyrightable material.

37. The method according to claim 26, wherein said copier related information includes information of a user identification associated with a user of a copier used for generation of an authorized copy of the content.

38. The method according to claim 26, wherein said copier related information includes information of an IP address associated with a copier used for generation of an authorized copy of the content.

39. The method according to claim 26, wherein said copier related information includes information of a copy device used for generation of an authorized copy of the content.

40. The method according to claim 26, further comprising: using copy control information provided with said content to determine whether an authorized copy of content may be generated.

41. The method according to claim 40, wherein said copy control information is provided in said adjunct.

42. The method according to claim 26, further comprising: receiving permission from a remote server before each generation of an authorized copy of the content.

43. A method for recording content distribution information in an adjunct to content, comprising:
performing a functional transformation on an adjunct to content each time an authorized copy of the content is generated so that said adjunct is modified to include copier related information for the generation of the authorized copy.

44. The method according to claim 43, wherein said functional transformation is characterized by an inverse transformation from which said copier related information is retrievable from the modified adjunct.

45. The method according to claim 44, wherein said functional transformation is an exclusive-OR function.

46. The method according to claim 43, wherein said adjunct is a watermark embedded in the content.

47. The method according to claim 43, wherein said adjunct is meta data associated with the content.

48. The method according to claim 43, wherein said adjunct is a signature related to the content.

49. The method according to claim 43, wherein the content is copyrightable material.

50. The method according to claim 43, wherein said copier related information includes information of a user identification associated with a user of a copier used for generation of an authorized copy of the content.

51. The method according to claim 43, wherein said copier related information includes information of an IP address associated with a copier used for generation of an authorized copy of the content.

52. The method according to claim 43, wherein said copier related information includes information of a copy device used for generation of an authorized copy of the content.

53. A method for recording content distribution information in an adjunct to content, comprising:
performing a functional transformation on an adjunct to content in a packet of data when said packet of data is relayed by a network node so that said adjunct is modified to include identifying information of said network node.

54. The method according to claim 53, wherein said adjunct is further modified to include information indicating an approximate time when said functional transformation is being performed.

55. The method according to claim 53, wherein said functional transformation is characterized by an inverse transformation from which said identifying information of said network node is retrievable from the modified adjunct.

56. The method according to claim 53, wherein each network node relaying said packet of data through a network to a final destination performs said functional transformation on the adjunct to content in said packet of data so that said adjunct is modified to include identifying information of all such network nodes by the time it reaches said final destination.

57. The method according to claim 53, wherein said adjunct is a watermark embedded in the content.

58. The method according to claim 53, wherein said adjunct is meta data associated with the content.

59. The method according to claim 53, wherein said adjunct is a signature related to the content.

60. A method for extracting content distribution information from a copy of content, comprising:
sequentially performing an inverse transformation on and extracting content distribution information from an adjunct to a copy of content until information of an original copy of the content is detected.

61. The method according to claim 60, wherein said content distribution information includes copier related information.

62. The method according to claim 61, wherein said inverse transformation corresponds to a functional transformation used to modify said adjunct with copier related information upon each successive generation of an authorized copy of the content originating from said original copy of the content.

63. The method according to claim 62, wherein said inverse transformation is an exclusive-OR function.

64. The method according to claim 63, wherein said functional transformation is an exclusive-OR function.

65. The method according to claim 60, wherein said adjunct is a watermark embedded in the content.

66. The method according to claim 60, wherein said adjunct is meta data associated with the content.

67. The method according to claim 60, wherein said adjunct is a signature related to the content.

68. The method according to claim 60, wherein said content is copyrightable material.

69. The method according to claim 61, wherein said copier related information includes information of a user identification associated with a user of a copier.

70. The method according to claim 61, wherein said copier related information includes information of an IP address associated a copier.

71. The method according to claim 61, wherein said copier related information includes information of a copy device used in generating a copy of the content by a copier.

72. A method for extracting content distribution information from a packet of data, comprising: sequentially performing an inverse transformation on and extracting content distribution information from an adjunct to content in the packet of data until information of a source of the packet of data is detected.

73. The method according to claim 72, wherein said inverse transformation corresponds to a functional transformation used to modify said adjunct with network node identifying information upon each relay of said packet of data from said source to a final destination.

74. The method according to claim 73, wherein said inverse transformation is an exclusive-OR function.

75. The method according to claim 74, wherein said functional transformation is an exclusive-OR function.

76. The method according to claim 72, wherein said adjunct is a watermark embedded in the content.

77. The method according to claim 72, wherein said adjunct is meta data associated with the content.

78. The method according to claim 72, wherein said adjunct is a signature related to the content.

79. The method according to claim 72, wherein said content distribution information includes information of an approximate time for each relay of said packet of data from an initial time that said packet left a source node to a current time associated with said extracting of content distribution information from said adjunct to content in the packet of data.

80. The method according to claim 79, wherein said approximate time includes information of a time zone associated with said approximate time.

81. The method according to claim 72, wherein an adjunct to content in a packet of data received at said final destination includes network node identifying information for all network nodes in a network through which said packet of data was relayed between said source to said final destination.

82. The method according to claim 81, wherein said network node identifying information for each network node includes an IP address for the network node.

83. The method according to claim 72, wherein said method is performed by a BOT on the network.

84. The method according to claim 83, wherein said method is performed by said BOT on each packet of data encountered by said BOT while scouring the network so that the content distribution information determined thereby is useful for determining a network topology for said network.

85. The method according to claim 84, wherein said content distribution information determined by said BOT scouring the network is also useful for determining supernodes in said network.

86. An apparatus for providing content distribution information in an adjunct to content, comprises a copier configured to: modify an adjunct to content by adding information associated with the copier to the adjunct when the copier is proceeding to have a copy generated which includes the modified adjunct and the content.

87. The apparatus according to claim 86, wherein said copier is a computer.

88. The apparatus according to claim 86, wherein said copier is a consumer electronic device.

89. The apparatus according to claim 86, wherein said copier is a set-top box.

90. The apparatus according to claim 86, wherein the copier is further configured to modify the adjunct by performing a functional transformation using information of the adjunct prior to such modification and the information associated with the copier.

91. The apparatus according to claim 90, wherein said functional transformation is characterized by an inverse transformation from which said information associated with said copier is retrievable from the modified adjunct.

92. The apparatus according to claim 86, wherein said adjunct is a watermark embedded in the content.

93. The apparatus according to claim 86, wherein said adjunct is meta data associated with the content.

94. The apparatus according to claim 86, wherein said adjunct is a signature related to the content.

95. The apparatus according to claim 86, wherein said content is copyrightable material.

96. The apparatus according to claim 86, wherein said information associated with said copier includes information of a user identification associated with a user of said copier.

97. The apparatus according to claim 86, wherein said information associated with said copier includes information of an IP address associated with said copier.

98. The apparatus according to claim 86, wherein said information associated with said copier includes information of a copy device used in generating said copy by said copier.

99. The apparatus according to claim 86, wherein said copier is further configured to cause said copy to be generated on a tangible medium.

100. The apparatus according to claim 86, wherein said copier is further configured to cause said copy to be generated as a downloadable file.

101. An apparatus for extracting content distribution information from a copy of content, comprising a device configured to sequentially perform an inverse transformation on and extract content distribution information from an adjunct to content until information of an original copy of the content is detected.

102. The apparatus according to claim 101, wherein said content distribution information includes copier related information.

103. The apparatus according to claim 102, wherein said inverse transformation corresponds to a functional transformation used to modify said adjunct with copier related information upon successive generations of authorized copies of the content originating from said original copy of the content.

104. The apparatus according to claim 101, wherein said inverse transformation is an exclusive-OR function.

104. The apparatus according to claim 101, wherein said adjunct is a watermark embedded in the content.

105. The apparatus according to claim 101, wherein said adjunct is meta data associated with the content.

106. The apparatus according to claim 101, wherein said adjunct is a signature related to the content.

107. The apparatus according to claim 101, wherein the content is copyrightable material.

108. The apparatus according to claim 102, wherein said copier related information includes information of a user identification associated with a user of a copier used to generate one of said authorized copies.

109. The apparatus according to claim 102, wherein said copier related information includes information of an IP address associated with a copier used to generate one of said authorized copies.

110. The apparatus according to claim 109, wherein said one of said authorized copies is a downloadable file.

111. The apparatus according to claim 101, wherein said copier related information includes information of a copy device used in generating one of said authorized copies.
